(19) United States
(12) Patent Application Publication
(10) Pub. No.: US 2005/0141064 A1
(43) Pub. Date: Jun. 30, 2005

(54) Hologram recording medium, and recording apparatus and reproducing apparatus for the same

(75) Inventors: Ikuo Aoki, Yokohama (JP); Yoshitaka Takahashi, Yokohama (JP)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/017,792

(22) Filed: Dec. 22, 2004

(30) Foreign Application Priority Data
Dec. 26, 2003 (JP) 2003-435434
Nov. 13, 2004 (KR) 2004-92795

(51) Int. Cl. G03H 1/02

(52) U.S. Cl. 359/3; 359/15

(57) ABSTRACT

A hologram recording medium, a recording apparatus and a recording method for the same, and a reproducing apparatus and a reproducing method for the same. The hologram recording medium is formed of a data recording region and a servo information recording region to allow a laser beam to be precisely irradiated for recording data on the hologram recording medium. Accordingly, data may be precisely recorded and reproduced from the hologram recording medium.

### CROSS-REFERENCE TO RELATED APPLICATION

This application claims priority to Japanese Patent Application No. 2003-435434, filed on Dec. 26, 2003, in the Japanese Intellectual Property Office, and to Korean Patent Application No. 2004-92795, filed on Nov. 13, 2004, in the Korean Intellectual Property Office, the disclosures of which are incorporated herein in their entirety by reference.

### BACKGROUND OF THE INVENTION

1. Field of the Invention

The present invention relates to a recording medium, and, more particularly, to a hologram recording medium to record data as a hologram.

2. Description of the Related Art

Recently, a rewritable optical disk of a phase shift type or an optical magnetic type has been widely used as an information recording medium. In order to increase the recording density of such an optical disk, reducing the diameter of a beam spot and the distance between adjacent tracks or adjacent bits is required. However, although the recording density of an optical disk has been increased, the recording density of an optical disk is physically limited by a diffraction limit of a beam to record data on a surface.

Accordingly, a three-dimensional multi-recording operation including a depth direction consideration is required to increase the recording density of an optical disk. As such, a hologram recording medium having a large capacity due to a three-dimensional multi-recording region and that can be used at a high speed due to a two-dimensional recording/reproducing method has attracted public attention as a next generation of computer recording media.

Although a hologram recording medium has been in development for a long time, recording and reproducing operations by using a simple recording medium, which is formed by inserting a recording material, such as a photo polymer, between two sheets of glass, have been mainly examined.

On the other hand, Japanese Laid-open Patent No. 2000-268380 discloses a technology of writing a location determination signal separately from data signals.

In such a case, data may be recorded on a whole surface of a recording medium. However, when reproducing data by using a different drive apparatus, controlling location determination so as to record and reproduce data in the correct locations on the recording/reproducing medium is difficult because eccentricities of the spindles are different in different drive apparatuses and the eccentricities of the spindles change when a new recording medium is loaded.

### SUMMARY OF THE INVENTION

The present invention provides a hologram recording medium on which data is recorded as a hologram by irradiating with a laser beam thereon at a high precision. The present invention also provides an apparatus to record data on a hologram recording medium and a method of recording data on the hologram recording medium. The present invention also provides an apparatus to reproduce data from a hologram recording medium and a method of reproducing data from the hologram recording medium.

According to an aspect of the present invention, there is provided a hologram recording medium comprising a data recording region and a servo information recording region. Accordingly, a hologram recording medium on which the location determination of an optical spot may be controlled to record a large amount of data is provided.

According to another aspect of the present invention, data is recorded in the data recording region. Since the data recording region is separated from the servo information recording region, the servo information recording region does not deteriorate the recording and reproducing of data.

The hologram recording medium may be formed in a disk shape, and the servo information recording region may be formed as concave units or convex units in a concentric circle shape relative to the data recording region. The hologram recording medium may be formed in a card shape, and the servo information recording region may be formed as concave units or convex units at both sides of the data recording region. Accordingly, data is recorded on the hologram recording medium in a simple structure as on a conventional CD or DVD.

According to another aspect of the present invention, a width of the data recording region along a radial direction of the disk shape may be larger than the effective diameter of interference fringes, which are generated by a signal beam and a reference beam. The width of the data recording inserted between the servo information recording regions may be larger than the effective diameter of interference fringes, which are generated by a signal beam and a reference beam. Accordingly, data is precisely recorded on and reproduced from the data recording region based on the location determination information of the optical spot, which is generated in the servo information recording region. A width of the servo information recording region along a radial direction of the disk shape may be smaller than the width of the data recording region. The width of the servo information recording region inserted between the data recording region may be smaller than the width of the data recording region. Since the width of the servo information recording region on which data is not recorded is minimized, the recording capacity of the hologram recording medium is increased.

According to yet another aspect of the present invention, there is provided an apparatus to record data on a hologram recording medium including a data recording region and a servo information recording region. The apparatus comprises a data recording unit to record data by irradiating a signal beam and a reference beam to the data recording region, and a location control unit to control the irradiation locations of the signal beam and the reference beam from the data recording unit by reading servo information from the servo information recording region.

In addition, a method of recording data on a hologram recording medium including a data recording region and a servo information recording region, comprises reading servo information from the servo information recording region, and determining a location to record data in the data recording region and recording data by irradiating a signal beam and a reference beam to the determined location of the data recording region.

Accordingly, the location determination of an optical spot, which is necessary to record data on the hologram recording medium, may be controlled.

According to still another aspect of the present invention, there is provided an apparatus to reproduce data from a hologram recording medium including a data recording region and a servo information recording region. The apparatus comprises a data reproducing unit to reproduce data by reading a reproduction beam that is generated by irradiating a reference beam to the data recording region, and a location control unit to control the irradiation location of the reference beam from the data reproducing unit by reading servo information from the servo information recording region.

In addition, a method of reproducing data from a hologram recording medium including a data recording region and a servo information recording region comprises reading servo information from the servo information recording region and determining a location to reproduce data from the data recording region; and reproducing data by reading a reproduction beam that is generated by irradiating a reference beam to the determined location of the data recording region.

Accordingly, the location determination of an optical spot necessary for reproducing data from the hologram recording medium may be controlled.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent by describing in detail exemplary embodiments thereof with reference to the attached drawings in which:

FIG. 1 is a sectional view of a hologram recording medium according to a first embodiment of the present invention;

FIGS. 2 through 5 are sectional views of examples of a hologram recording medium according to a second embodiment of the present invention, respectively;

FIG. 6 illustrates a hologram recording medium in a card shape according to the present invention;

FIG. 7 illustrates a hologram recording medium in a disk shape according to the present invention;

FIG. 8 is a block diagram of a recording apparatus for a hologram recording medium according to the present invention; and

FIG. 9 is a block diagram of a reproducing apparatus for a hologram recording medium according to the present invention.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

In a recording operation for a conventional hologram recording medium, a signal beam and a reference beam are irradiated towards a hologram memory cell. Meanwhile, interference fringes are recorded in the hologram memory cell by an interference phenomenon between the signal beam and the reference beam. In a reproducing operation for a conventional hologram recording medium, a reference beam is irradiated and a signal beam is reproduced as a reproduction beam due to a principle of hologram operation. In this case, the reproduction beam includes the data of the signal beam, which is recorded on the hologram memory cell. Thus, the hologram memory cell may be used as an information recording apparatus.

A characteristic of a hologram recording medium is the capability of repeated recording of more than two items of data in one cell. In other words, a second reference beam is irradiated to a hologram recording medium on which predetermined data is already recorded using a first signal beam and a first reference beam, at a different angle from the first reference beam. Meanwhile, a second signal beam, having different data from that of the first signal beam, is irradiated at the same angle as the first signal beam. As a result, second interference fringes are repeatedly recorded on the hologram memory cell due to the interference phenomenon of the second reference beam and the second signal beam.

When irradiating the second reference beam in a reproducing operation, a second reproduction beam having the same data as the second signal beam is generated. As a result, a plurality of data may be repeatedly recorded on the same cell.

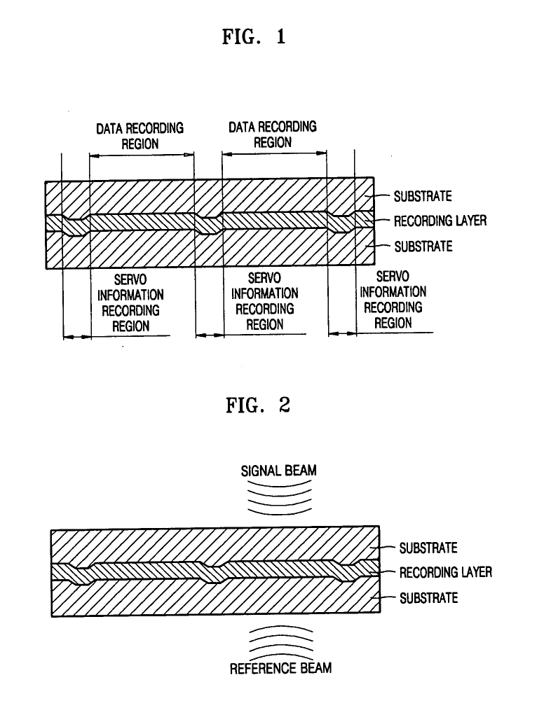

A hologram recording medium to be used in accordance with the above processes is formed by inserting a recording layer between two substrates, as shown in FIG. 1. In this case, the recording layer may be formed of a material having a high reproducing efficiency and resolution. The material should also allow for repeated recording and erasing of data without causing a deterioration of the high reproducing efficiency and resolution characteristics of the material. A non-limiting example of the material for the recording layer is niobic acidic lithium single crystal.

FIG. 1 is a sectional view of a hologram recording medium according to a first embodiment of the present invention. Referring to FIG. 1, a recording layer is inserted between two substrates, and servo information recording regions are formed at both sides of a data recording region of the recording layer in a concave shape.

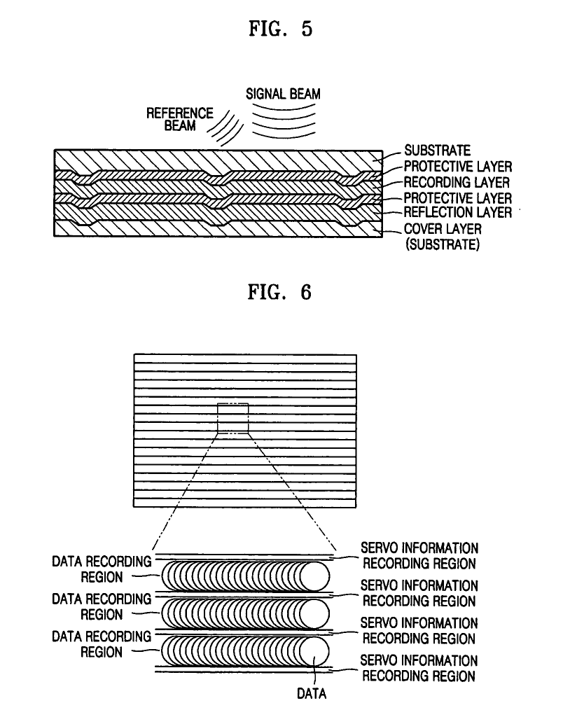

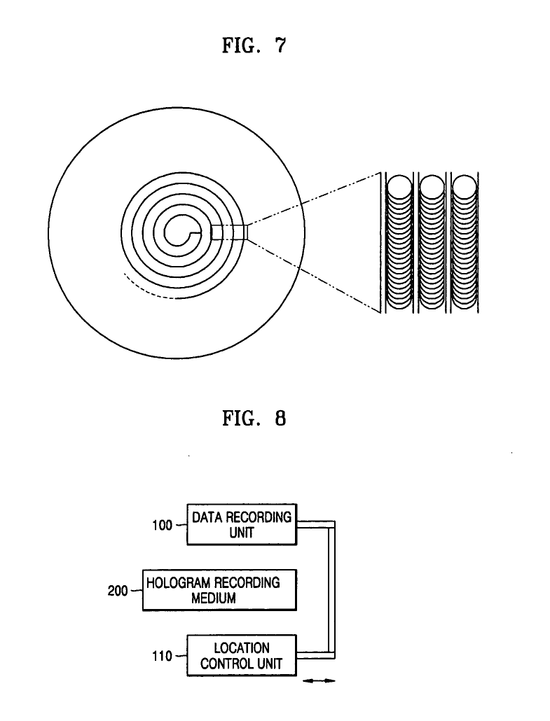

The hologram recording medium may be card shaped or disk shaped, like a CD or a DVD, although these are non-limiting embodiments of the present invention. When forming the hologram recording medium in a disk shape, layers including a recording layer are deposited on a substrate having concave or convex units in a concentric circle shape or a spiral shape, as shown in FIG. 7. When forming the hologram recording medium in a card shape, layers including a recording layer are deposited on a substrate having concave or convex units in parallel with a long side of the card shaped hologram recording medium as shown in FIG. 6. In both cases, data is shift multi-recorded in parallel with servo information recording regions, as shown in FIGS. 6 and 7. Accordingly, a data recording region may be separated from the servo information recording regions.

In addition, data is recorded in the data recording region, not in the servo information recording regions. Since the servo information recording regions are formed in a concave or a convex shape, interference fringes cannot be recorded on the servo information recording regions.

The servo information recording region is used to generate a servo signal to precisely determine the location of an optical spot of a laser beam that is irradiated toward the data recording region when recording and reproducing data. In this case, the servo signal is generated by a push-pull method, which is generally used for a CD or a DVD.

In addition, the width of the data recording region may be determined to be slightly larger than the effective diameter of interference fringes, which are generated by a signal beam and a reference beam. The width of the servo information recording regions may be determined to be as small as possible because data cannot be recorded in the servo information recording regions. In this case, the widths of the data recording region and the servo information recording region denote the length of a radial direction of a disk shaped hologram recording medium and the length of a short side of a card shaped hologram recording medium.

In another embodiment of the invention, the widths of the regions may be determined based on the generation method of the servo signals.

FIGS. 2 through 5 are sectional views of a hologram recording medium according to a second embodiment of the present invention.

FIG. 2 is a sectional view of a hologram recording medium in the case of irradiating a signal beam to one surface and a reference beam to the other surface of the hologram recording medium, which has a substantially similar structure as that of the hologram recording medium of FIG. 1.

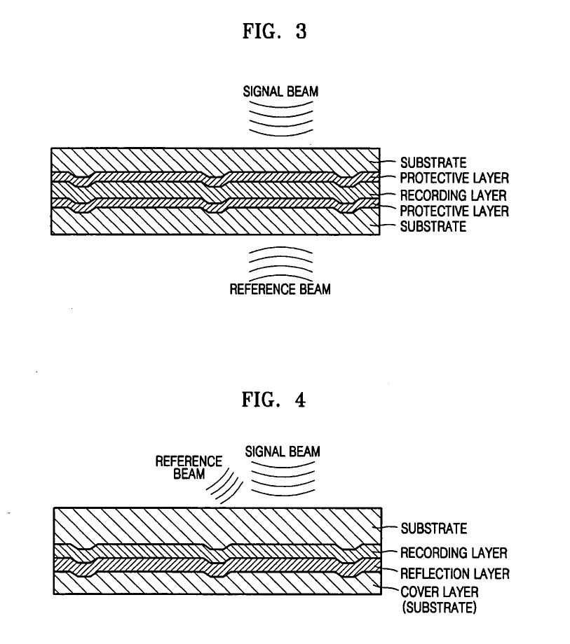

FIG. 3 is a sectional view of a hologram recording medium having protective layers at both sides of a recording layer.

FIG. 4 is a sectional view of a hologram recording medium where a signal beam and a reference beam are irradiated toward a surface of the hologram recording medium. In this case, the hologram recording medium also includes a reflection layer that faces the irradiated signal beam and reference beam.

In addition, FIG. 5 is a sectional view of a hologram recording medium having protective layers at both surfaces of a recording layer. In this case, the hologram recording medium also includes a reflection layer adjacent to the one of the protective layers that is located at an opposite side of the recording layer relative to an input direction of the signal beam and the reference beam.

The hologram recording media of FIGS. 2 through 5 may be formed in a card shape or a disk shape and include a data recording region and servo information recording regions, respectively.

FIG. 8 is a block diagram illustrating a recording apparatus for a hologram recording medium according to another embodiment of the present invention. A hologram recording medium 200 including a data recording region and servo information recording regions is shown. Referring to FIG. 8, the recording apparatus for a hologram recording medium, according to the present invention, includes a data recording unit 100 and a location control unit 110.

The data recording unit 100 irradiates a signal beam and a reference beam toward the data recording region of the hologram recording medium 200 so as to record data. The location control unit 110 reads servo information from the servo information recording regions of the hologram recording medium 200 so as to control the irradiation location of the signal beam and the reference beam from the data recording unit 100.

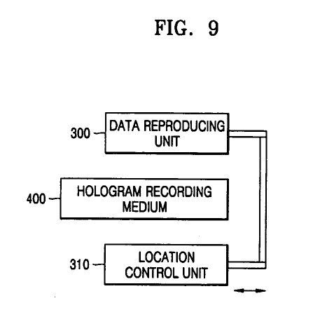

FIG. 9 is a block diagram illustrating a reproducing apparatus for a hologram recording medium according to the present invention. A hologram recording medium 400 including a data recording region and servo information recording regions is shown for the convenience of description. Referring to FIG. 9, the reproducing apparatus for a hologram recording medium according to the present invention includes a data reproducing unit 300 and a location control unit 310. The data reproducing unit 300 reads a reproduction beam, which is generated by irradiating a reference beam to the data recording region of the hologram recording medium 400, to reproduce data. The location control unit 310 reads servo information from the servo information recording regions of the hologram recording medium 400 so as to control the irradiation location of the reference beam from the data reproducing unit 300.

In additional embodiments of the invention, the hologram recording medium may be formed in various other non-limiting shapes. For example, the hologram recording medium according to the present invention may be formed in a cube shape.

Although a few embodiments of the present invention have been shown and described, it would be appreciated by those skilled in the art that changes may be made in these embodiments without departing from the principles and spirit of the invention, the scope of which is defined in the claims and their equivalents.

1. A hologram recording medium comprising:
a data recording region; and
a servo information recording region.

2. The hologram recording medium of claim 1, wherein data is recorded in the data recording region.

3. The hologram recording medium of claim 1, wherein the medium is formed in a disk shape, and the servo information recording region is formed as concave or convex units in a concentric circle shape relative to the data recording region.

4. The hologram recording medium of claim 3, wherein a width of the data recording region along a radial direction of the disk shape is larger than an effective diameter of interference fringes that are generated by a signal beam and a reference beam.

5. The hologram recording medium of claim 3, wherein a width of the servo information recording region along a radial direction of the disk shape is smaller than a width of the data recording region.

6. The hologram recording medium of claim 1, wherein the medium is formed in a card shape, and the servo information recording region is formed as concave or convex units at both sides of the data recording region.

7. The hologram recording medium of claim 6, wherein a width of a data recording inserted between the servo information recording region is larger than an effective diameter of interference fringes that are generated by a signal beam and a reference beam.

8. The hologram recording medium of claim 6, wherein a width of the servo information recording region inserted between the data recording region is smaller than a width of the data recording region.

9. An apparatus to record data on a hologram recording medium including a data recording region and a servo information recording region, the apparatus comprising:
a data recording unit to record the data by irradiating a signal beam and a reference beam toward the data recording region; and
a location control unit to control locations of the signal beam and the reference beam irradiated from the data recording unit by reading servo information from the servo information recording region.

10. The apparatus of claim 9, wherein the hologram recording medium is formed in a disk shape, and the servo information recording region is formed as concave or convex units in a concentric circle shape relative to the data recording region.

11. The apparatus of claim 9, wherein the hologram recording medium is formed in a card shape and the servo information recording region is formed as concave or convex units at both sides of the data recording region.

12. A method of recording data on a hologram recording medium including a data recording region and a servo information recording region, the method comprising:
reading servo information from the servo information recording region and determining a location to record the data in the data recording region; and
recording the data by irradiating a signal beam and a reference beam toward the determined location of the data recording region.

13. The method of claim 12, wherein the hologram recording medium is formed in a disk shape, and the servo information recording region is formed as concave or convex units in a concentric circle shape relative to the data recording region.

14. The method of claim 12, wherein the hologram recording medium is formed in a card shape and the servo information recording region is formed as concave or convex units at both sides of the data recording region.

15. An apparatus to reproduce data from a hologram recording medium including a data recording region and a servo information recording region, the apparatus comprising:
a data reproducing unit to reproduce the data by reading a reproduction beam, which is generated by irradiating a reference beam toward the data recording region; and
a location control unit to control an irradiation location of the reference beam from the data reproducing unit by reading servo information from the servo information recording region.

16. The apparatus of claim 15, wherein the hologram recording medium is formed in a disk shape, and the servo information recording region is formed as concave or convex units in a concentric circle shape relative to the data recording region.

17. The apparatus of claim 15, wherein the hologram recording medium is formed in a card shape, and the servo information recording region is formed as concave or convex units at both sides of the data recording region.

18. A method of reproducing data from a hologram recording medium including a data recording region and a servo information recording region, the method comprising:
reading servo information from the servo information recording region and determining a location to reproduce the data from the data recording region; and
reproducing the data by reading a reproduction beam generated by irradiating a reference beam toward the determined location of the data recording region.

19. The method of claim 18, wherein the hologram recording medium is formed in a disk shape, and the servo information recording region is formed as concave or convex units in a concentric circle shape relative to the data recording region.

20. The method of claim 18, wherein the hologram recording medium is formed in a card shape, and the servo information recording region is formed as concave or convex units at both sides of the data recording region.

21. An apparatus to record/reproduce data onto/from a hologram recording/reproducing medium, wherein the medium comprises:
a pair of substrates;
a recording/reproducing layer, having a data recording/reproducing region, to be inserted between the pair of substrates; and
a servo information recording region, adjacent to the data recording/reproducing region and shaped such that an interference fringe cannot be recorded thereon, to generate a servo signal so as to determine where a signal beam and a reference beam should be irradiated when recording/reproducing data onto/from the recording/reproducing layer.

22. The apparatus according to claim 21, wherein the medium is card shaped and the recording/reproducing layer is deposited in parallel with a long side.

23. The apparatus according to claim 21, wherein the medium is disk shaped and the recording/reproducing layer is deposited in a concentrically circular or spiral shape.

24. The apparatus according to claim 21, wherein the servo information regions are either concave or convex.

25. The apparatus according to claim 21, wherein the servo signal is generated by a push pull method.

26. The apparatus according to claim 21, wherein a width of the data recording/reproducing region is relatively slightly larger than an effective diameter of an interference fringe generated by the signal beam and the reference beam.

27. The apparatus according to claim 26, wherein a width of the servo information recording region is comparatively small compared to the data recording/reproducing region.

28. The apparatus according to claim 21, wherein the medium further comprises protective layers on either side of the recording/reproducing layer.

29. The apparatus according to claim 28, wherein the medium is card shaped and the recording/reproducing layer is deposited in parallel with a long side.

30. The apparatus according to claim 28, wherein the medium is disk shaped and the recording/reproducing layer is deposited in a concentrically circular or spiral shape.

31. The apparatus according to claim 21, wherein the medium further comprises a reflection layer to face the signal beam and the reference beam, which are irradiated from the same side of the medium.

32. The apparatus according to claim 31, wherein the medium is card shaped and the recording/reproducing layer is deposited in parallel with a long side.

33. The apparatus according to claim 31, wherein the medium is disk shaped and the recording/reproducing layer is deposited in a concentrically circular or spiral shape.

34. The apparatus according to claim 28, wherein the medium further comprises protective layers on either side of the recording/reproducing layer, wherein the reflection layer is adjacent to the one of the protective layers that is located at an opposite side of the recording layer relative to an input direction of the signal beam and the reference beam.
